(19) United States
(12) Patent Application Publication
(10) Pub. No.: US 2022/0401766 A1
(43) Pub. Date: Dec. 22, 2022

(54) SYSTEMS AND METHODS FOR SUPPRESSING FIRE IN A LAVATORY OF A VEHICLE

(71) Applicant: THE BOEING COMPANY, CHICAGO, IL (US)

(72) Inventor: Darren Carl McIntosh, Mukilteo, WA (US)

(73) Assignee: THE BOEING COMPANY, CHICAGO, IL (US)

(21) Appl. No.: 17/720,401

(22) Filed: Apr. 14, 2022

Related U.S. Application Data
(60) Provisional application No. 63/213,238, filed on Jun. 22, 2021.

(51) Int. Cl. A62C 2/04; A62C 3/08

(52) U.S. Cl. CPC A62C 2/04; A62C 3/08

(57) ABSTRACT

A fire suppression system for an enclosed space, such as within a lavatory of a vehicle, includes a first inner gate, a second inner gate coupled to the first inner gate to define one or more air channels therethrough, and a temperature-responsive device coupled to one or both of the first inner gate or the second inner gate. The temperature-responsive device is configured to be in a first state below a predetermined temperature threshold, and a second state above the predetermined temperature threshold. In the second state, the second inner gate is moved relative to the first inner gate to close the one or more air channels.

### CROSS-REFERENCE TO RELATED APPLICATIONS

This application relates to and claims priority benefits from U.S. Provisional Patent Application No. 63/213,238, filed Jun. 22, 2021, which is hereby incorporated by reference in its entirety.

### FIELD OF THE DISCLOSURE

Embodiments of the present disclosure generally relate to systems and methods for suppressing fire in an enclosed space, such as within a lavatory within an internal cabin of a commercial aircraft.

### BACKGROUND OF THE DISCLOSURE

Commercial aircraft are used to transport passengers between various locations. A typical commercial aircraft includes one or more lavatories within an internal cabin.

Airline customers are increasingly requesting the use of lavatories to store excess bagged trash. Multiple bags of trash may be stowed in one or more lavatories when the internal cabin is being prepared for landing and the lavatories are locked and unused.

Certain regulations, such as promulgated by the U.S. Federal Aviation Administration (FAA), require lavatories within commercial aircraft to be able to contain a fire therein in less than 30 minutes. Indeed, the FAA has strict requirements in relation to such fire containment. Testing for such requirements typically includes ignition of multiple bags of trash (for example, four large bags of trash).

Further, certain regulations also require a lavatory door of a commercial aircraft to have an open grille in order to satisfy certain decompression requirements. The open grille also allows negative air flow pressure within the lavatory, to prevent odors escaping into the main cabin. The fire containment and the decompression requirements can conflict, as the open grille allows air to pass therethrough and potentially feed a fire, as demonstrated during certain tests. Known lavatory doors include grilles that are always open, and therefore create an uninterrupted flow of air into any fire within the lavatory.

### SUMMARY OF THE DISCLOSURE

A need exists for a system and method for effectively and efficiently suppressing fire within a lavatory of a commercial aircraft.

With that need in mind, certain examples of the present disclosure provide a fire suppression system, including a first inner gate, a second inner gate coupled to the first inner gate to define one or more air channels therethrough, and a temperature-responsive device coupled to one or both of the first inner gate or the second inner gate. The temperature-responsive device is configured to be in a first state below a predetermined temperature threshold, and a second state above the predetermined temperature threshold. In the second state, the second inner gate is moved relative to the first inner gate to close the one or more air channels.

In at least one example, the fire suppression system is coupled to a grille of a door. In at least one example, a lavatory includes the door. In at least one example, the door is coupled to an enclosed space within an internal cabin of a vehicle.

In at least one example, the temperature-responsive device includes a eutectic alloy fusible link.

In at least one example, the temperature-responsive device includes a button, and a thermoplastic pin extending into the button.

In at least one example, the first inner gate includes a fixed open frame, and the second inner gate includes a louver moveably coupled to the fixed open frame.

Certain examples of the present disclosure provide a fire suppression method, including maintaining a temperature-responsive device coupled to one or both of a first inner gate or a second inner gate in a first state below a predetermined temperature threshold; transitioning the temperature-response device to a second state above the predetermined temperature threshold; and in response to said transitioning, moving the second inner gate relative to the first inner gate to close one or more air channels defined through the first inner gate or the second inner gate when the temperature-responsive device is in the first state.

Certain examples of the present disclosure provide a vehicle including an internal cabin, and an enclosed space within the internal cabin. The enclosed space includes a door having a grille and a fire suppression system coupled to the grille, as described herein.

### BRIEF DESCRIPTION OF THE DRAWINGS

FIG. 1 illustrates a perspective front view of an aircraft, according to an embodiment of the present disclosure.

FIG. 2 illustrates a perspective internal view of a lavatory, according to an embodiment of the present disclosure.

FIG. 3 illustrates a schematic block diagram of a fire suppression system for a lavatory within an internal cabin of an aircraft, according to an embodiment of the present disclosure.

FIG. 4 illustrates a flow chart of a fire suppression method for a lavatory within an internal cabin of an aircraft, according to an embodiment of the present disclosure.

FIG. 5 illustrates an isometric front view of a door having a grille, according to an embodiment of the present disclosure.

FIG. 6 illustrates an isometric exploded view of a fire suppression system, according to an embodiment of the present disclosure.

FIG. 7 illustrates an isometric view of the fire suppression system of FIG. 6.

FIG. 8 illustrates a lateral view of the fire suppression system having the temperature-responsive device in a first state during normal operation, according to an embodiment of the present disclosure.

FIG. 9 illustrates a lateral view of the fire suppression system as a predetermined temperature threshold is reached, according to an embodiment of the present disclosure.

FIG. 10 illustrates a lateral view of the fire suppression system having the temperature-responsive device in a second state after the predetermined temperature threshold is reached, according to an embodiment of the present disclosure.

FIG. 11A illustrates an isometric view of a fire suppression system, according to an embodiment of the present disclosure.

FIG. 11B illustrates a top edge view of the fire suppression system of FIG. 11A.

FIG. 12 illustrates an isometric view of a door having the fire suppression system, according to an embodiment of the present disclosure.

FIG. 13 illustrates a lateral view of the fire suppression system having the temperature-responsive device in a first state during normal operation, according to an embodiment of the present disclosure.

FIG. 14 illustrates a lateral view of the fire suppression system as a predetermined temperature threshold is reached, according to an embodiment of the present disclosure.

FIG. 15 illustrates a lateral view of the fire suppression system having the temperature-responsive device in a second state after the predetermined temperature threshold is reached, according to an embodiment of the present disclosure.

FIG. 16 illustrates a lateral view of the fire suppression system having the temperature-responsive device in a first state during normal operation, according to an embodiment of the present disclosure.

FIG. 17 illustrates a lateral view of the fire suppression system as a predetermined temperature threshold is reached, according to an embodiment of the present disclosure.

FIG. 18 illustrates a lateral view of the fire suppression system having the temperature-responsive device in a second state after the predetermined temperature threshold is reached, according to an embodiment of the present disclosure.

FIG. 19 illustrates a flow chart of a fire suppression method, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Certain examples of the present disclosure provide a vehicle (such as a commercial aircraft) including an internal cabin. A lavatory is within the internal cabin. The lavatory includes a door having a grille and a fire suppression system coupled to the grille. The fire suppression system includes a first inner gate, a second inner gate coupled to the first inner gate to define an air channel therethrough, and a temperature-responsive device coupled to one or both of the first inner gate or the second inner gate. The temperature-responsive device is in a first state below a predetermined temperature threshold, and a second state above the predetermined temperature threshold. In the second state, the second inner gate is moved relative to the first inner gate to close the air channel.

As an example, the temperature-responsive device includes a eutectic alloy fusible link. As an example, the temperature-responsive device includes a button, and a thermoplastic pin extending into the button.

In at least one example, the first inner gate includes a fixed open frame, and the second inner gate includes a louver moveably coupled to the fixed open frame

Certain examples of the present disclosure provide an entry door for a lavatory of a commercial aircraft that includes a fire suppression system. In at least one example, the fire prevention system includes a louver, or gated system that allows two independent modes of operation specific to the aircraft. A first mode allows the lavatory door grille to permit airflow in a decompression event, while also allowing airflow to maintain negative air pressure within the lavatory. A second mode is configured to automatically change state in response to one or more circumstances (such as a predetermined temperature threshold or range). In particular, in the second mode, the louver or gate automatically closes to prevent airflow into the lavatory.

In at least one example, the fire suppression system includes a eutectic alloy fusible link that is configured to activate at a precise predetermined temperature threshold. For example, the link can be configured to meet the FAA requirement for 30 minute fire containment, which is unique to aircraft certification. In at least one example, the fire suppression system is configured to meet the unique requirements for airplane certification, such as with respect to flammability, air pressure differentials, a decompression event, temperature differentials in normal operation as well as during the event of a fire within the lavatory, vibration, reliability, endurance, abuse and fail safe, and the like. Optionally, the fire suppression system can be used on doors of various other enclosed spaces, whether in other vehicles or fixed structures.

In at least one embodiment, the fire suppression system includes a gate/louver that is configured to close in response to a predetermined temperature being reached (such as via operation of the eutectic alloy fusible link), thereby suffocating a fire of airflow. When the temperature is lower than the predetermined temperature, gate/louver is in an open position, thereby addressing decompression and negative airflow requirements.

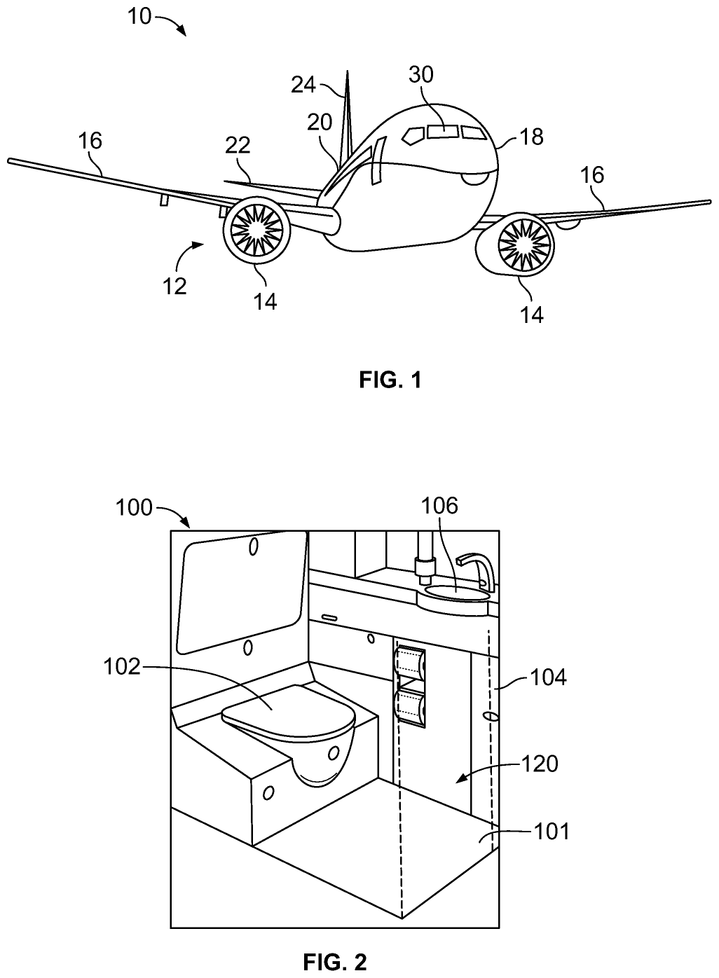

FIG. 1 illustrates a perspective front view of an aircraft 10, according to an embodiment of the present disclosure. The aircraft 10 includes a propulsion system 12 that includes engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin 30, which includes a flight deck or cockpit, one or more work sections (for example, galleys, personnel carry-on baggage areas, and the like), one or more passenger sections (for example, first class, business class, and coach sections), one or more lavatories, and/or the like. At least one of the lavatories within the internal cabin 30 includes a fire suppression system, as described herein.

Alternatively, instead of an aircraft, embodiments of the present disclosure may be used with various other vehicles, such as automobiles, buses, locomotives and train cars, watercraft, and the like. Further, embodiments of the present disclosure may be used with respect to fixed structures, such as commercial and residential buildings.

FIG. 2 illustrates a perspective internal view of a lavatory 100, according to an embodiment of the present disclosure. The lavatory 100 is an example of an enclosed space or chamber, such as within the internal cabin of the aircraft 10, shown in FIG. 1. The lavatory 100 may be onboard an aircraft, as described above. Optionally, the lavatory 100 may be onboard various other vehicles. In other embodiments, the lavatory 100 may be within a fixed structure, such as a commercial or residential building. The lavatory 100 includes a base floor 101 that supports a toilet 102, cabinets 104, and a sink 106 or wash basin. The lavatory 100 may be arranged differently than shown. The lavatory 100 may include more or less components than shown.

The lavatory 100 also includes an entry door 120. As described herein, the door 120 includes a grille that includes a fire suppression system.

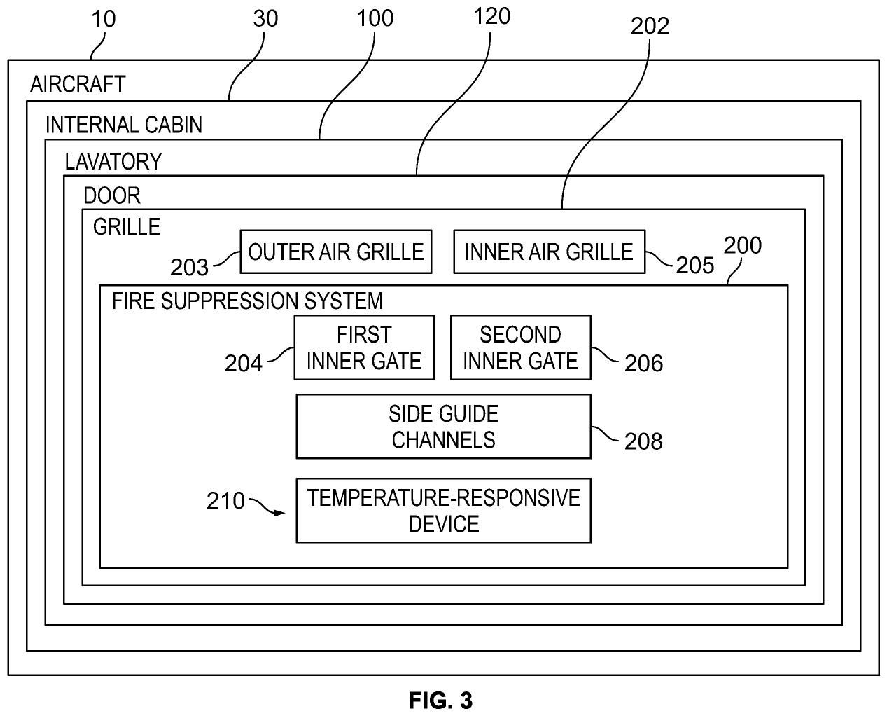

FIG. 3 illustrates a schematic block diagram of a fire suppression system 200 for a lavatory 100 within an internal cabin 30 of an aircraft 10, according to an embodiment of the present disclosure. The fire suppression system 200 is coupled to a grille assembly (or grille) 202 within a door (or panel) 120 of the lavatory 100. The grille 202 can include an outer air grille 203 and an inner air grille 205.

In at least one example, the door 120 can be manufactured having the fire suppression system 200. As another example, a grille of an existing door can be removed, and the door can be retrofit with the grille 202 having the fire suppression system 200.

The fire suppression system 200 includes a first inner gate 204 coupled to a second inner gate 206. For example, the first inner gate 204 is a fixed, stationary gate, and the second inner gate 206 is moveable in relation to the first inner gate 204. Optionally, the first inner gate 204 can be the moveable gate, and the second inner gate 206 can be the fixed, stationary gate. The fire suppression system 200 can also include side guide channels 208 (for example, guide channels formed in lateral rails that support one or both of the first inner gate 204 and/or the second inner gate 206).

A temperature-responsive device 210 is coupled to one or both of the first inner gate 204 and/or the second inner gate 206. The temperature-responsive device 210 is configured to change states in response to a predetermined temperature being reached. In at least one embodiment, the temperature-responsive device 210 is a eutectic alloy fusible link. The predetermined temperature can be a temperature at which fire ignites within the lavatory 100. For example, the predetermined temperature can be a temperature determined by the FAA in relation to one or more fire suppression regulations.

In operation, when the temperature within the lavatory 100 is below the predetermined temperature, the temperature-response device 210 is in a first state, and maintains the first gate 204 and the second gate 206 in an open position, such that one or more air channels are open therethrough and allow air to pass into the lavatory 100. In response to the predetermined temperature being reached (that is, a predetermined temperature threshold), the temperature-responsive device 210 automatically changes to a second state (such as by melting). In at least one example, the second inner gate 206 is moveably coupled to the temperature-responsive device 210. As the temperature-responsive device 210 changes to the second state, the second inner gate 206 moves in response thereto, thereby closing the one or more air channels, and preventing airflow into the lavatory 100.

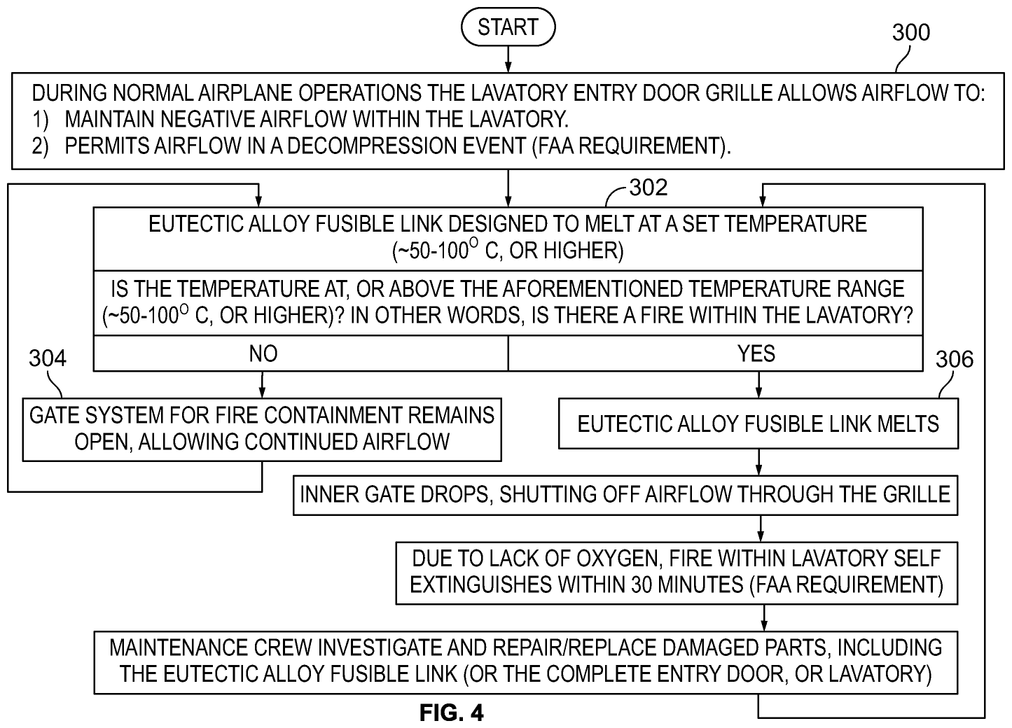

FIG. 4 illustrates a flow chart of a fire suppression method for a lavatory within an internal cabin of an aircraft, according to an embodiment of the present disclosure. Referring to FIGS. 3 and 4, at 300, during normal operations, the grille 202 allows airflow to maintain negative airflow within the lavatory and permit airflow in a decompression event. As such, the fire suppression system 200 within the grille 202 has the temperature-responsive device 210 in the first state, in which the first inner gate 204 and the second inner gate 206 are in an open position, such that one or more air channels pass therethrough.

At 302, in response to the predetermined temperature threshold being reached, the temperature-responsive device 210 transitions to the second state. For example, a eutectic alloy fusible link melts at the predetermined temperature threshold (for example, a temperature exceeding 50 degrees Celsius).

If the temperature has not reached the predetermined threshold, the fire suppression system 200 maintains the first inner gate 204 and the second inner gate 206 in the open position at 304. If, however, the temperature has reached the predetermined threshold, at 306, the temperature-responsive device 210 transitions to the second state (such as by melting), the second inner gate 206 drops, closes the air channel (thereby moving the gates 204 and 206 into a closed position), and thereby shuts off airflow through the grille 202.

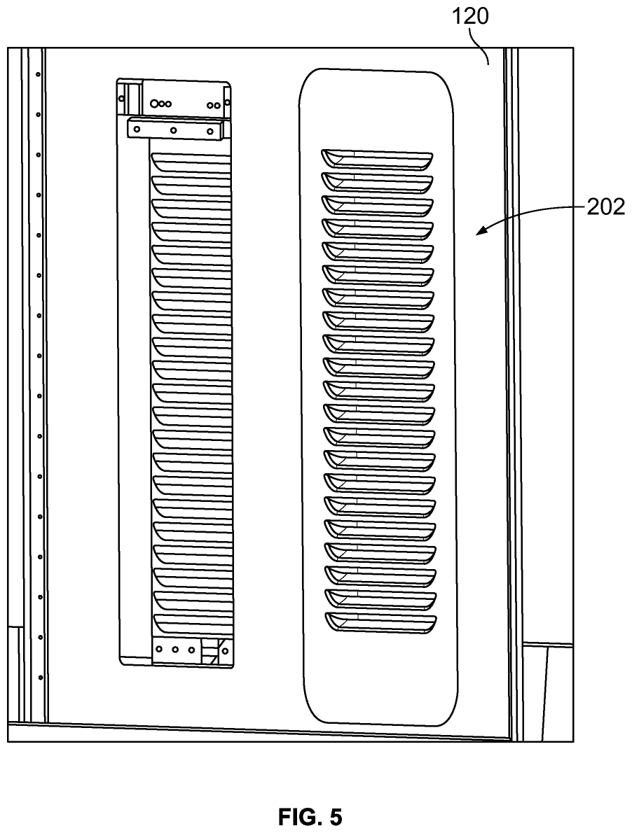

FIG. 5 illustrates an isometric front view of a door 120 having a grille 202, according to an embodiment of the present disclosure. The grille 202 includes a fire suppression system, as described herein. In at least one example, the door 120 is part of a lavatory, such as within an internal cabin of a vehicle (for example, a commercial aircraft).

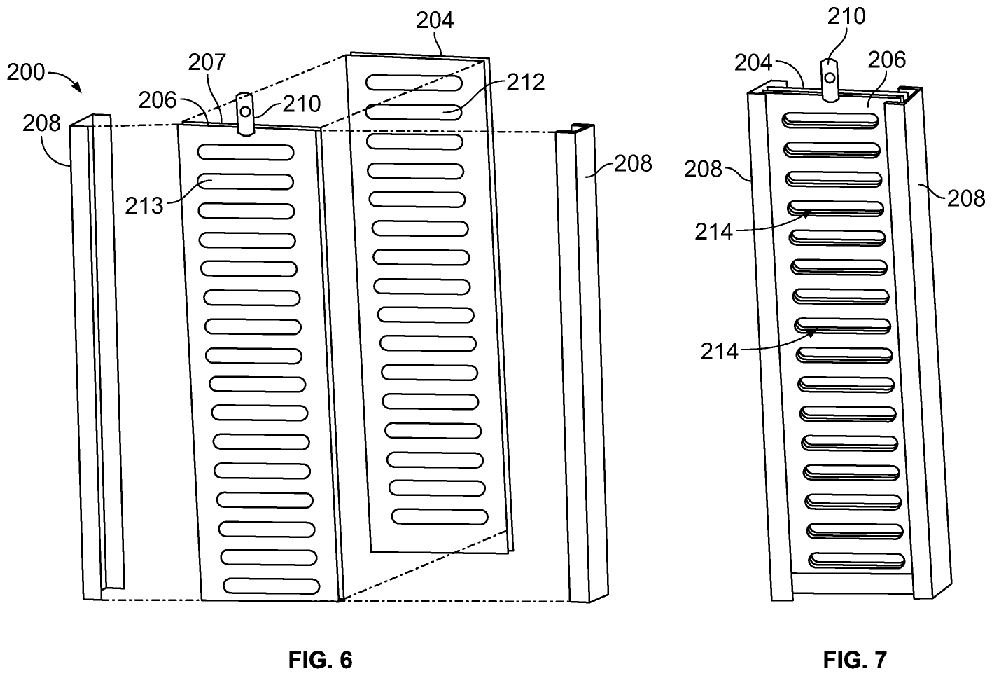

FIG. 6 illustrates an isometric exploded view of a fire suppression system 200, according to an embodiment of the present disclosure. FIG. 7 illustrates an isometric view of the fire suppression system of FIG. 6. Referring to FIGS. 6 and 7, the fire suppression system 200 includes the first inner gate 204, the second inner gate 206, the side guide channels 208, and the temperature-responsive device 210 (such as a eutectic fusible link) coupled to a fixed portion of the door (not shown in FIGS. 6 and 7) and the second inner gate 206, such as a top edge or portion 207 of the second inner gate 206. The first and second inner gates 204 and 206 include openings 212 (for example, first openings) and 213 (for example, second openings), respectively, that align to provide open air channels 214 that pass through the grille 202 when the temperature-responsive device 210 is in a first state (such as when the temperature is less than the predetermined temperature threshold).

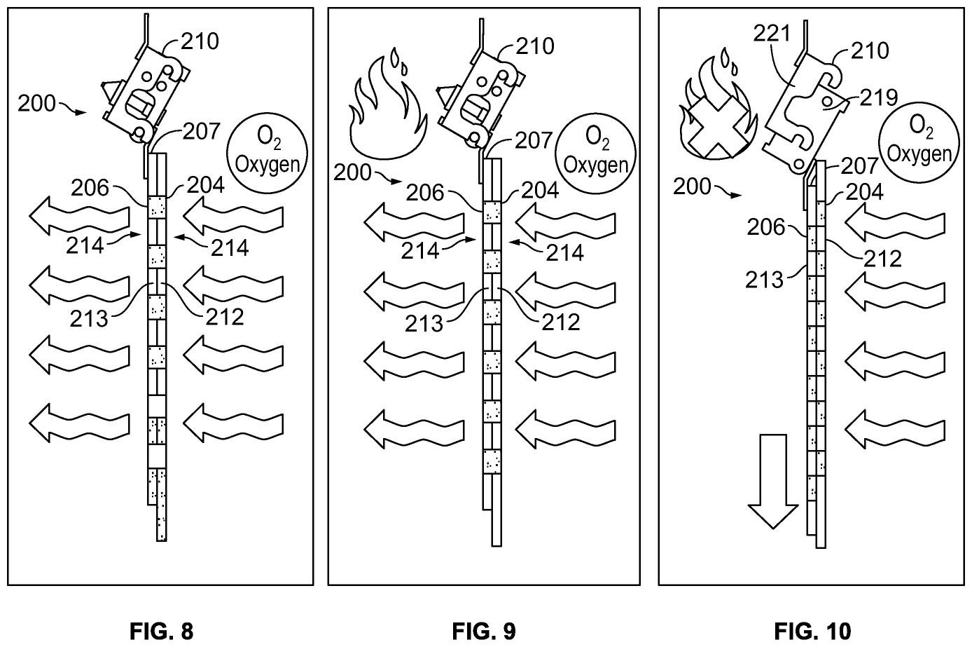

FIG. 8 illustrates a lateral view of the fire suppression system 200 having the temperature-responsive device in a first state during normal operation, according to an embodiment of the present disclosure. FIG. 9 illustrates a lateral view of the fire suppression system 200 as a predetermined temperature threshold is reached. FIG. 10 illustrates a lateral view of the fire suppression system 200 having the temperature-responsive device in a second state after the predetermined temperature threshold is reached.

As shown in FIG. 10, when the temperature-responsive device 210 transitions to the second state (such as having at least one portion that melts), the second inner gate 206 shifts downwardly in relation to the first inner gate 204, thereby mis-aligning the openings 212 and 213, and closing the open air channels 214 (shown in FIGS. 8 and 9, but are blocked in FIG. 10). For example, as the temperature-responsive device 210 transitions to the second state, a lower portion 219 of the temperature-responsive device 210 downwardly shifts in relation to a fixed upper portion 221, thereby forcing the second inner gate 206 downwardly, and mis-aligning the openings 212 and 213.

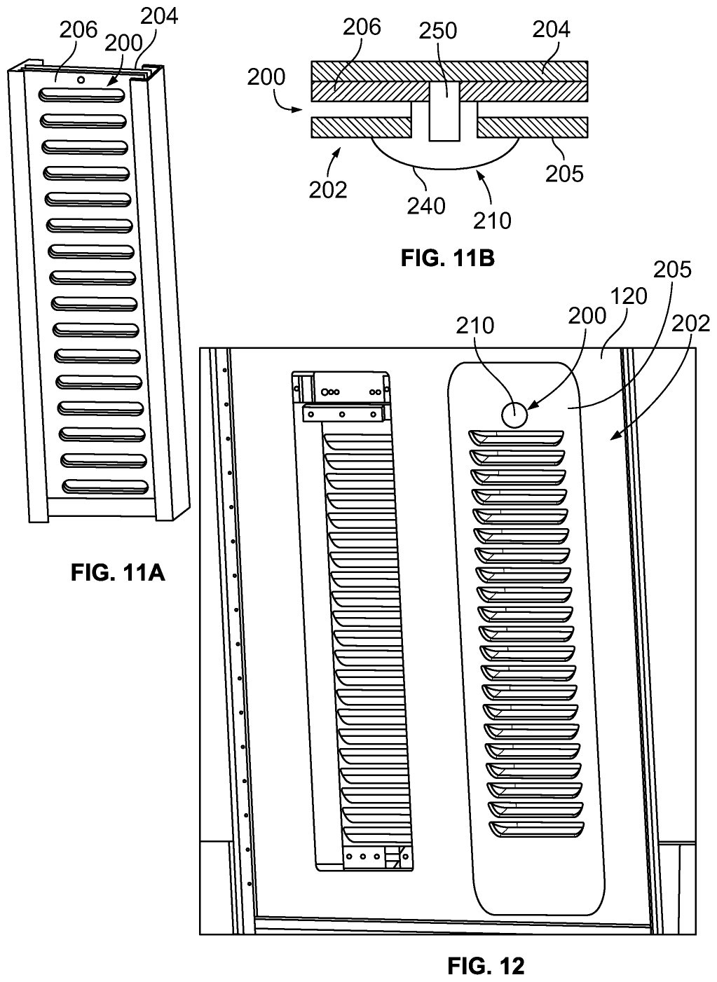

FIG. 11A illustrates an isometric view of a fire suppression system 200, according to an embodiment of the present disclosure. FIG. 11B illustrates a top edge view of the fire suppression system 200 of FIG. 11A. FIG. 12 illustrates an isometric view of a door 120 having the fire suppression system 200, according to an embodiment of the present disclosure.

Referring to FIGS. 11A, 11B, and 12, in this example, the temperature-responsive device 210 includes a button 240 (for example, a thermal conductive button, such as formed of copper, brass, or the like) secured to the grille 202 (such as the inner air grille 205 or optionally, the outer air grille 203), and a thermoplastic pin 250 extending into the button 240 and into the second inner gate 206. The pin 250 is configured to melt at the predetermined temperature threshold. When the pin 250 melts, the pin 250 disengages from the second inner gate 206 (for example, melts within and away from a retaining channel of the second inner gate 206). Consequently, the second inner gate 206 drops in relation to the first inner gate 204 to close off the open air channel.

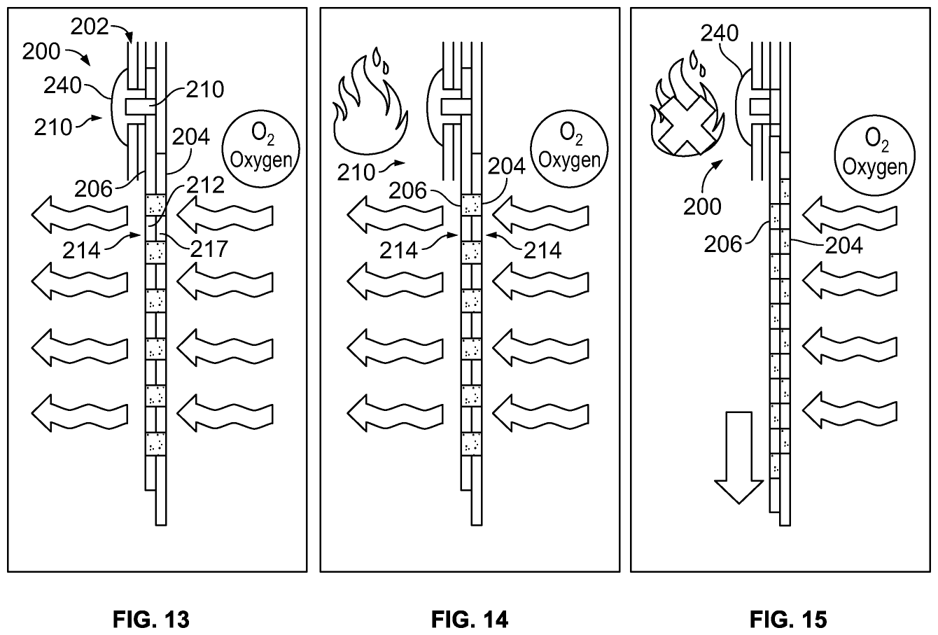

FIG. 13 illustrates a lateral view of the fire suppression system 200 having the temperature-responsive device 210 in a first state during normal operation, according to an embodiment of the present disclosure. FIG. 14 illustrates a lateral view of the fire suppression system 200 as a predetermined temperature threshold is reached, according to an embodiment of the present disclosure. FIG. 15 illustrates a lateral view of the fire suppression system 200 having the temperature-responsive device 210 in a second state after the predetermined temperature threshold is reached.

In at least one embodiment, the fire suppression system 200 can include the temperature-responsive device 210 shown and described with respect to FIGS. 6-10 and the temperature-responsive device 210 shown and described with respect to FIGS. 11A-15.

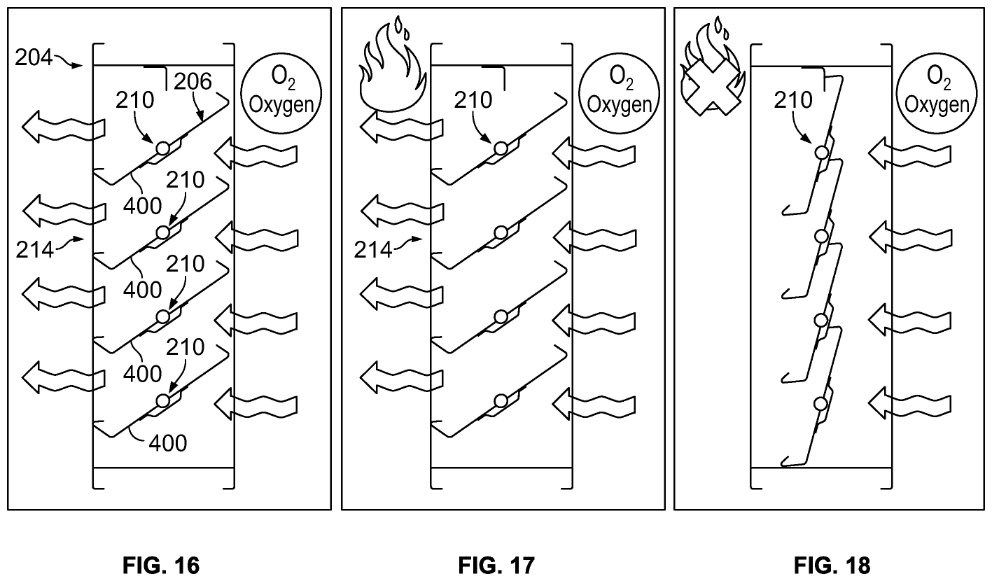

FIG. 16 illustrates a lateral view of the fire suppression system 200 having the temperature-responsive device 210 in a first state during normal operation, according to an embodiment of the present disclosure. FIG. 17 illustrates a lateral view of the fire suppression system 200 as a predetermined temperature threshold is reached, according to an embodiment of the present disclosure. FIG. 18 illustrates a lateral view of the fire suppression system 200 having the temperature-responsive device 210 in a second state after the predetermined temperature threshold is reached, according to an embodiment of the present disclosure.

In the example shown in FIGS. 16-18, the first inner gate 204 can be a fixed open frame, and the second inner gate 206 can be a moveable louver secured inside the fixed open frame. The temperature-responsive device 210 (such as any of those described herein) is coupled to the moveable louver, such as via a spring-loaded or stored energy device. As shown in FIG. 16, when the temperature-responsive device 210 is in the first state (below the predetermined temperature threshold), the panels of 400 the louver are oriented to form the air channels 214 through the fixed open frame and the louver. When the predetermined threshold is reached, the temperature-responsive device transitions to the second state, and, in response, the panels 400 of the louver move to close off the air channels 214, such that the louver is in the closed position shown in FIG. 18.

As shown, the moveable louver can include one or more panels 400 coupled to one or more temperature-responsive devices 210. The fire suppression system 200 can include more or less panels 400 and temperature-responsive devices 210 than shown in FIGS. 16-18.

In at least one embodiment, the fire suppression system 200 can include the temperature-responsive device 210 shown in FIGS. 16-18 and one or both of the temperature-responsive device 210 shown and described with respect to FIGS. 6-10 and/or the temperature-responsive device 210 shown and described with respect to FIGS. 11A-15.

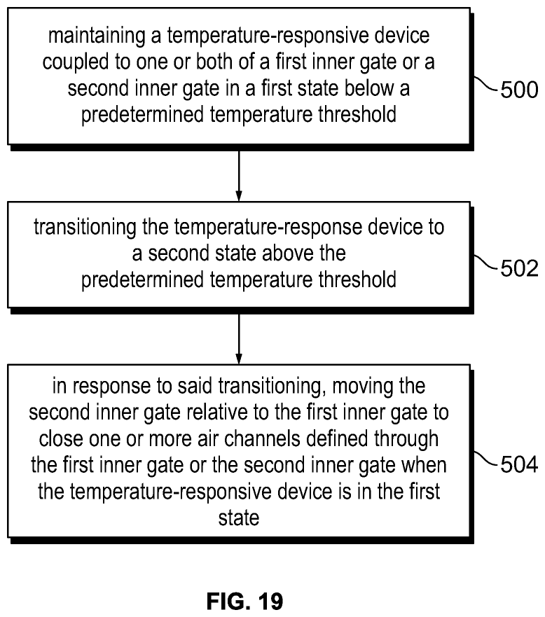

FIG. 19 illustrates a flow chart of a fire suppression method, according to an embodiment of the present disclosure. Referring to FIGS. 3 and 19, the fire suppression method includes maintaining 500 the temperature-responsive device 210 coupled to one or both of the first inner gate 204 or the second inner gate 206 in the first state below a predetermined temperature threshold; transitioning 502 the temperature-response device 210 to the second state above the predetermined temperature threshold; and in response to the transitioning 502, moving the second inner gate 206 relative to the first inner gate 204 to close one or more air channels 214 (shown in FIG. 7, for example) defined through the first inner gate 204 or the second inner gate 206 when the temperature-responsive device 210 is in the first state.

Further, the disclosure comprises examples according to the following clauses:

Clause 1. A fire suppression system, comprising:

a first inner gate;

a second inner gate coupled to the first inner gate to define one or more air channels therethrough; and

a temperature-responsive device coupled to one or both of the first inner gate or the second inner gate,

wherein the temperature-responsive device is configured to be in a first state below a predetermined temperature threshold, and a second state above the predetermined temperature threshold, and

wherein in the second state, the second inner gate is moved relative to the first inner gate to close the one or more air channels.

Clause 2. The fire suppression system of Clause 1, wherein the fire suppression system is coupled to a grille of a door.

Clause 3. The fire suppression system of Clause 2, wherein a lavatory includes the door.

Clause 4. The fire suppression system of Clause 2, wherein the door is coupled to an enclosed space within an internal cabin of a vehicle.

Clause 5. The fire suppression system of any of Clauses 1-4, wherein the temperature-responsive device comprises a eutectic alloy fusible link.

Clause 6. The fire suppression system of any of Clauses 1-5, wherein the temperature-responsive device comprises:

a button; and

a thermoplastic pin extending into the button.

Clause 7. The fire suppression system of any of Clauses 1-6, wherein the first inner gate comprises a fixed open frame, and wherein the second inner gate comprises a louver moveably coupled to the fixed open frame.

Clause 8. A fire suppression method, comprising:

maintaining a temperature-responsive device coupled to one or both of a first inner gate or a second inner gate in a first state below a predetermined temperature threshold;

transitioning the temperature-response device to a second state above the predetermined temperature threshold; and

in response to said transitioning, moving the second inner gate relative to the first inner gate to close one or more air channels defined through the first inner gate or the second inner gate when the temperature-responsive device is in the first state.

Clause 9. The fire suppression method of Clause 8, wherein the fire suppression system is coupled to a grille of a door.

Clause 10. The fire suppression method of Clause 9, wherein a lavatory includes the door.

Clause 11. The fire suppression method of Clause 9, wherein the door is coupled to an enclosed space within an internal cabin of a vehicle.

Clause 12. The fire suppression method of any of Clauses 8-11, wherein the temperature-responsive device comprises a eutectic alloy fusible link.

Clause 13. The fire suppression method of any of Clauses 8-12, wherein the temperature-responsive device comprises:

a button; and

a thermoplastic pin extending into the button.

Clause 14. The fire suppression method of any of Clauses 8-13, wherein the first inner gate comprises a fixed open frame, and wherein the second inner gate comprises a louver moveably coupled to the fixed open frame.

Clause 15. A vehicle comprising:

an internal cabin;

an enclosed space within the internal cabin, the enclosed space including a door having a grille and a fire suppression system coupled to the grille, the fire suppression system comprising:
a first inner gate;
a second inner gate coupled to the first inner gate to define one or more air channels therethrough; and
a temperature-responsive device coupled to one or both of the first inner gate or the second inner gate,
wherein the temperature-responsive device is configured to be in a first state below a predetermined temperature threshold, and a second state above the predetermined temperature threshold, and
wherein in the second state, the second inner gate is moved relative to the first inner gate to close the one or more air channels.

Clause 16. The vehicle of Clause 15, wherein the vehicle is an aircraft.

Clause 17. The vehicle of Clauses 15 or 16, wherein the enclosed space is a lavatory.

Clause 18. The vehicle of any of Clauses 15-17, wherein the temperature-responsive device comprises a eutectic alloy fusible link.

Clause 19. The vehicle of any of Clauses 15-18, wherein the temperature-responsive device comprises:

a button; and

a thermoplastic pin extending into the button.

Clause 20. The vehicle of any of Clauses 15-19, wherein the first inner gate comprises a fixed open frame, and wherein the second inner gate comprises a louver moveably coupled to the fixed open frame.

As described herein, examples of the present disclosure provide systems and methods for effectively and efficiently suppressing fire, such as within a lavatory of a commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A fire suppression system, comprising:
a first inner gate;
a second inner gate coupled to the first inner gate to define one or more air channels therethrough; and
a temperature-responsive device coupled to one or both of the first inner gate or the second inner gate,
wherein the temperature-responsive device is configured to be in a first state below a predetermined temperature threshold, and a second state above the predetermined temperature threshold, and
wherein in the second state, the second inner gate is moved relative to the first inner gate to close the one or more air channels.

2. The fire suppression system of claim 1, wherein the fire suppression system is coupled to a grille of a door.

3. The fire suppression system of claim 2, wherein a lavatory includes the door.

4. The fire suppression system of claim 2, wherein the door is coupled to an enclosed space within an internal cabin of a vehicle.

5. The fire suppression system of claim 1, wherein the temperature-responsive device comprises a eutectic alloy fusible link.

6. The fire suppression system of claim 1, wherein the temperature-responsive device comprises:
a button; and
a thermoplastic pin extending into the button.

7. The fire suppression system of claim 1, wherein the first inner gate comprises a fixed open frame, and wherein the second inner gate comprises a louver moveably coupled to the fixed open frame.

8. A fire suppression method, comprising:
maintaining a temperature-responsive device coupled to one or both of a first inner gate or a second inner gate in a first state below a predetermined temperature threshold;
transitioning the temperature-response device to a second state above the predetermined temperature threshold; and
in response to said transitioning, moving the second inner gate relative to the first inner gate to close one or more air channels defined through the first inner gate or the second inner gate when the temperature-responsive device is in the first state.

9. The fire suppression method of claim 8, wherein the fire suppression system is coupled to a grille of a door.

10. The fire suppression method of claim 9, wherein a lavatory includes the door.

11. The fire suppression method of claim 9, wherein the door is coupled to an enclosed space within an internal cabin of a vehicle.

12. The fire suppression method of claim 8, wherein the temperature-responsive device comprises a eutectic alloy fusible link.

13. The fire suppression method of claim 8, wherein the temperature-responsive device comprises:
a button; and
a thermoplastic pin extending into the button.

14. The fire suppression method of claim 8, wherein the first inner gate comprises a fixed open frame, and wherein the second inner gate comprises a louver moveably coupled to the fixed open frame.

15. A vehicle comprising:
an internal cabin;
an enclosed space within the internal cabin, the enclosed space including a door having a grille and a fire suppression system coupled to the grille, the fire suppression system comprising:
a first inner gate;
a second inner gate coupled to the first inner gate to define one or more air channels therethrough; and
a temperature-responsive device coupled to one or both of the first inner gate or the second inner gate,
wherein the temperature-responsive device is configured to be in a first state below a predetermined temperature threshold, and a second state above the predetermined temperature threshold, and
wherein in the second state, the second inner gate is moved relative to the first inner gate to close the one or more air channels.

16. The vehicle of claim 15, wherein the vehicle is an aircraft.

17. The vehicle of claim 15, wherein the enclosed space is a lavatory.

18. The vehicle of claim 15, wherein the temperature-responsive device comprises a eutectic alloy fusible link.

19. The vehicle of claim 15, wherein the temperature-responsive device comprises:
a button; and
a thermoplastic pin extending into the button.

20. The vehicle of claim 15, wherein the first inner gate comprises a fixed open frame, and wherein the second inner gate comprises a louver moveably coupled to the fixed open frame.
